(19) United States
(12) Patent Application Publication
(10) Pub. No.: US 2026/0288915 A1
(43) Pub. Date: Sep. 24, 2026

(54) ARTIFICIAL INTELLIGENCE TRACEABILITY SYSTEM

(71) Applicant: Stahl Industries LLC, Dallas, TX (US)

(72) Inventors: Andrew Kenneth Stahl, Dallas, TX (US); JOSÉ ALBERTO MÁRQUEZ BENÍTEZ, Mexico City (MX)

(21) Appl. No.: 19/087,962

(22) Filed: Mar. 24, 2025

(51) Int. Cl. G06F 21/16; H04L 9/32

(52) U.S. Cl. CPC G06F 21/16; H04L 9/3236

(57) ABSTRACT

Systems and methods generate a unique agent identifier for each artificial intelligent (AI) agent of a plurality of AI agents utilized in a given networked system. The systems and methods, for each detect execution of each of the plurality of AI agents, generate a data unique tag comprising the unique agent identifier associated with an AI agent that was executed, a time stamp associated with execution, and contextual metadata, and assign the data unique tag to AI-generated data generated from the execution of the AI agent. The systems and methods generate a watermark for new data created by a downstream application where the watermark is based on each data unique tag associated with the accessed data. The systems and methods store the watermark with the new data to enable tracing of AI influence across the given networked system.

### BACKGROUND

The integration of artificial intelligence (AI), such as generative AI (GenAI), into business applications has revolutionized data-driven decision-making, content creation, and operational efficiency. GenAI technologies are increasingly used to generate insights, automate processes, and drive innovation across industries. Despite the transformative benefits, the adoption of GenAI introduces a critical challenge: the lack of comprehensive traceability mechanisms for the data and processes influenced by AI.

Without traceability, organizations face risks associated with data integrity, regulatory non-compliance, opaque decision-making, and the inability to detect and address biases in AI-influenced outcomes.

### BRIEF DESCRIPTION OF THE DRAWINGS

The drawings provided are for illustrative purposes and do not restrict the scope of this disclosure.

FIG. 1 is a block diagram illustrating a networked system, consistent with some examples.

FIG. 2 is a flow chart illustrating aspects of a method, consistent with some examples.

FIG. 3 is a block diagram illustrating an example of a software architecture that may be installed on a machine, consistent with some examples.

FIG. 4 illustrates a diagrammatic representation of a machine, in the form of a computer system, within which a set of instructions may be executed for causing the machine to perform any one or more of the methodologies discussed herein, consistent with some examples.

### DETAILED DESCRIPTION

As organizations increasingly adopt generative AI systems, a critical technical problem is the inability to trace and verify how AI-generated content influences downstream business processes and decision-making. Traceability in AI refers to the ability to monitor, document, and verify every aspect of the lifecycle of AI-generated content and process flows, including the algorithmic models, the configurations, the knowledge base, the inputs, the outputs as well as the downstream impacts. This feature is essential to ensure accountability, reproducibility, and transparency in AI-powered systems. Specifically, when AI-generated outputs are used across multiple systems and processes, organizations lack the technical controls to track the origin, verify compliance, and detect potential issues like bias or incorrect data sources.

An AI traceability system is described herein that addresses these technical problems by implementing a multi-level traceability framework that creates unique identifiers and watermarks to track direct AI outputs and their downstream influence. For example, in financial systems using AI for analytics, the framework enables organizations to trace where answers originated and verify if correct data sources were used. The system captures critical metadata about the AI agent's configuration, such as model parameters, knowledge base versions, and prompts, and then propagates this information through watermarks as the data flows through different applications and processes.

Further, application programming interfaces (APIs) and orchestration capabilities enable integrated tracking and verification across enterprise systems. By embedding watermarks and maintaining detailed downstream records, organizations can implement technical controls to detect bias, validate decision-making processes, and ensure compliance requirements are met. This addresses the fundamental technical challenge of maintaining traceability when AI-generated content is modified, augmented, or used as input for subsequent processes and decisions.

For example, the AI traceability system generates a unique agent identifier for each artificial intelligent (AI) agent of a plurality of AI agents utilized in a given networked system. The AI traceability system detects each execution of a plurality of executions of each of the plurality of AI agents utilized in the given networked system.

For each detected execution, the AI traceability system generates a data unique tag comprising the unique agent identifier associated with an AI agent that was executed, a time stamp associated with execution, and contextual metadata and assigns the data unique tag to AI-generated data generated from the execution of the AI agent. The AI traceability system detects accessed data by a downstream application, the accessed data comprising AI-generated data generated from execution of one or more AI agents of the plurality of AI agents and generates a watermark for new data created by the downstream application, the watermark based on each data unique tag associated with the accessed data. The AI traceability system can store the watermark with the new data to enable tracing of AI influence across the given networked systems.

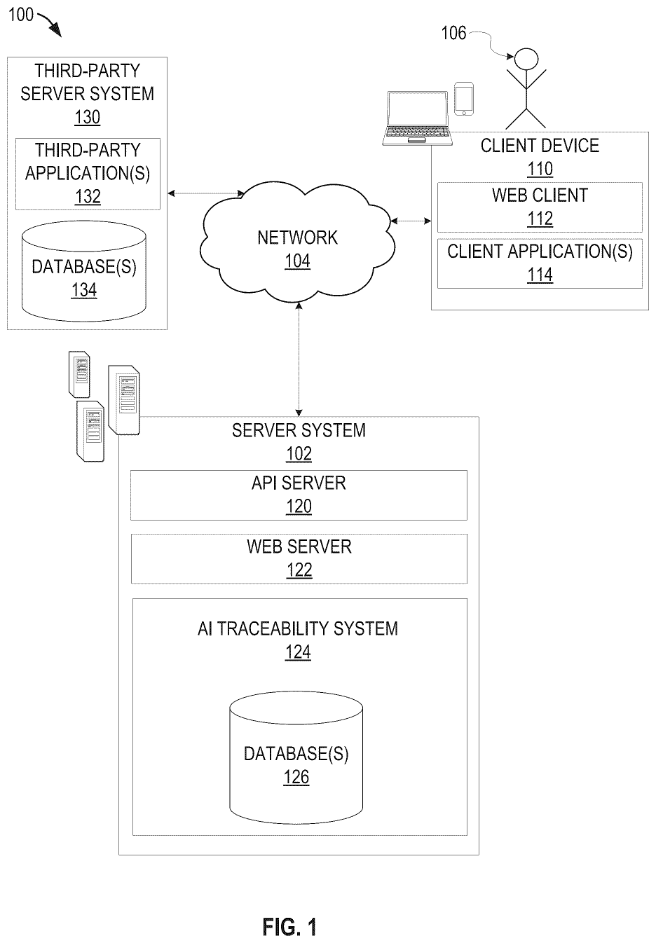

FIG. 1 is a block diagram illustrating a networked system 100, according to some example embodiments. The system 100 can include one or more client devices such as client device 110. The client device 110 can comprise, but is not limited to, a mobile phone, desktop computer, laptop, portable digital assistant (PDA), smart phone, tablet, Ultrabook, netbook, laptop, multi-processor system, microprocessor-based or programmable consumer electronic, game console, set-top box, computer in a vehicle, wearable computing device, or any other computing or communication device that a user may utilize to access the networked system 100. In some embodiments, the client device 110 comprises a display module (not shown) to display information (e.g., in the form of user interfaces). In further embodiments, the client device 110 can comprise one or more of touch screens, accelerometers, gyroscopes, cameras, microphones, global positioning system (GPS) devices, and so forth. The client device 110 can be a device of a user 106 that is used to access and utilize an AI traceability system 124 for queries, reporting and other applications.

One or more users 106 may be a person, a machine, or other means of interacting with the client device 110. In example embodiments, the user 106 may not be part of the system 100 but can interact with the system 100 via the client device 110 or other means. For instance, the user 106 can provide input (e.g., touch screen input or alphanumeric input) to the client device 110 and the input can be communicated to other entities in the system 100 (e.g., third-party server system 130, server system 102) via a network 104. In this instance, the other entities in the system 100, in response to receiving the input from the user 106, communicate information to the client device 110 via the network 104 to be presented to the user 106. In this way, the user 106 can interact with the various entities in the system 100 using the client device 110.

The system 100 further includes a network 104. One or more portions of network 104 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 can access the various data and applications provided by other entities in the system 100 via web client 112 (e.g., a browser, such as the Internet Explorer® browser developed by Microsoft® Corporation of Redmond, Washington State) or one or more client applications 114. The client device 110 can include one or more client applications 114 (also referred to as “apps”) such as, but not limited to, a web browser, a search engine, a messaging application, an electronic mail (email) application, an e-commerce site application, a mapping or location application, an enterprise resource planning application, a customer relationship management application, an application for accessing and utilizing the AI traceability system 124, and the like.

In some embodiments, one or more client applications 114 are included in a given client device 110, and configured to locally provide the user interface and at least some of the functionalities, with the client application(s) 114 configured to communicate with other entities in the system 100 (e.g., third-party server system 130, server system 102, etc.), on an as-needed basis, for data and/or processing capabilities not locally available (e.g., access location information, access machine learning models, to authenticate a user 106, to verify a method of payment, access the hierarchical agentic retrieval and reasoning system 124, and so forth), and so forth. Conversely, one or more client applications 114 may not be included in the client device 110, and then the client device 110 can use its web browser to access the one or more applications hosted on other entities in the system 100 (e.g., third-party server system 130, server system 102).

A server system 102 provides server-side functionality via the network 104 (e.g., the Internet or wide area network (WAN)) to one or more third-party server system 130 and/or one or more client devices 110. The server system 102 can include an application program interface (API) server 120, a web server 122, and an AI traceability system 124 that can be communicatively coupled with one or more databases 126.

The one or more databases 126 comprise storage devices that store data related to users of the system 100, applications associated with the system 100, cloud services, machine learning models, data related to entities/products/services, and so forth. The one or more databases 126 can further store information related to third-party server system 130, third-party applications 132, third-party database(s) 134, client devices 110, client applications 114, users 106, and so forth. In one example, the one or more databases 126 is cloud-based storage. In some examples, the one or more databases 126 stores data related to data utilized by the AI traceability system 124, as explained in further detail below.

The server system 102 can be a cloud computing environment, according to some example embodiments. The server system 102, and any servers associated with the server system 102, can be associated with a cloud-based application, in one example embodiment.

The AI traceability system 124 provides back-end support for third-party applications 132 and client applications 114, which can include cloud-based applications. The AI traceability system 124 provides mechanisms for enabling traceability in AI-influenced data and processes across business applications. The AI traceability system 124 can comprise one or more servers or other computing devices or systems.

As mentioned above, the AI traceability system 124 provides a multi-level traceability framework to monitor, document, and verify AI agents, AI-generated data, and AI-influenced data. In some examples, the AI agents are GenAI-powered agents, the AI-generated data is GenAI-generated data, and AI-influenced data is GenAI-influenced data. By implementing structured traceability mechanisms, the AI traceability system 124 ensures seamless identification, attribution, and lineage tracking of AI-influenced outcomes. As described further below, the AI traceability system 124 uses unique tagging to ensure seamless identification and attribution across all traceability levels.

As indicated above, one example of AI is generative AI (GenAI).

Generative AI is a term that can refer to artificial intelligence technology that can create new content based on learned patterns from large training datasets when prompted by systems or users. Input data for a generative AI agent can include text, audio, image, video, numeric, or prompts, and the output data can include text, images, video, audio, code, or synthetic data. Some examples of GenAI include large language models (LLMs) such as Llama, Mistral GPT, Claude, Gemini, PaLM, Command R, Luminous, and the like.

The system 100 further includes one or more third-party server system 130. The one or more third-party server system 130 can include one or more third-party application(s). The one or more third-party application(s) 132, executing on third-party server(s) 130, can interact with the server system 102 via API server 120 via a programmatic interface provided by the API server 120. For example, one or more of the third-party applications 132 can request and utilize information from the server system 102 via the API server 120 to support one or more features or functions on a website hosted by the third party or an application hosted by the third party.

The third-party website or application 132, for example, can provide access to functionality and data supported by third-party server system 130. In one example embodiment, the third-party website or application 132 provides access to functionality that is supported by relevant functionality and data in the third-party server system 130. In another example, a third-party server system 130 is a system associated with an entity that accesses cloud services via server system 102.

The third-party database(s) 134 can be storage devices that store data related to users of the third-party server system 130, applications associated with the third-party server system 130, cloud services, machine learning models, parameters, and so forth.

The one or more databases 126 can further store information related to third-party applications 132, client devices 110, client applications 114, users 106, and so forth. In one example, the one or more databases 134 are cloud-based storage.

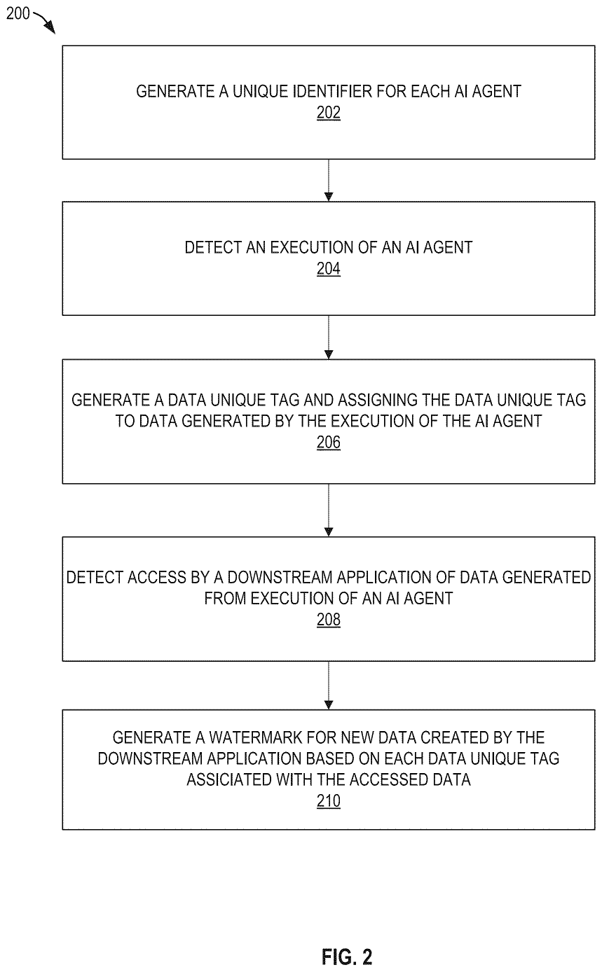

FIG. 2 is a flow chart illustrating aspects of a method 200, according to some example embodiments. For illustrative purposes, method 200 is described with respect to the block diagram of FIG. 1. It is to be understood that method 200 can be practiced with other system configurations in other embodiments.

In operation 202, a computing system, such as the server system 102 or AI traceability system 124, generates a unique agent identifier for each AI agent of a plurality of AI agents utilized in a given networked system. For example, an organization can use a number of different types of machine learning models in various applications through its networked computing system. In some examples, the AI agent is a machine learning model such as a GenAI model, as mentioned above. In some examples, one or more AI agent is a GenAI-powered agent composed by large language model (LLM) instances and Retrieval-Augmented Generation (RAG) pipelines, to generate data by GenAI-powered applications. To achieve traceability at this level, the computing system generates a unique agent identifier for each AI agent, incorporating several metadata elements.

One example metadata element is an application version. The application version identifies the specific version of the business application leveraging the GenAI-powered agent. For example, the application version can be an App Tag that includes an application name and application version. An example format for the App Tag is [App_Name]_[App_Version]. For instance, for an invoice generation application with a version 1.2.0, the App Tag can be generated as: InvoiceGen_1.2.0, in one example.

Other example metadata elements include model (e.g., LLM) specifics. In some examples, the model specifics include a model name, version, and associated parameters used during a particular execution of the AI agent. The parameters can include temperature (e.g., how creative or how conservative the model's output will be), maximum number of tokens, and other parameters. For example, this metadata element can include a Model Tag that includes an LLM name and an LLM version. An example format for the Model Tag is: [LLM_Name]_[LLM_Version]. Using GPT4 with a version 2023.09 as a specific example of a model, the Model Tag can be generated as GPT4_2023.09, for instance.

This metadata element can also include a Parameters Tag that encodes key call parameters, such as temperature and maximum tokens; as mentioned above. An example format for the Parameters Tag is: T[Temperature]_MT[MaxTokens] and a specific example is T0.7_MT1000.

Yet another example metadata element includes a knowledge base version that tracks the versioning of a knowledge base used by the RAG pipeline, including data type/domain and data classification (e.g., confidentiality level). For example, this metadata element can include a Knowledge Base Tag that includes a knowledge base name, a knowledge base version and data classification. An example format for the Knowledge Base Tag is [KB_Name]_[KB_Version]_[Data_Classification] and a specific example is CustomerSupportKB_3.1_Public.

Another example metadata element is a prompt version. A prompt is a message or command to instruct an AI agent to produce a specific output. Prompts can be sentences, questions, data, or the like. This metadata element includes the specific version of a prompt used to query the LLM or RAG system, including any modifications (branching) of templates. For example, this metadata element can include a Prompt Version Tag that tracks evolution of prompt templates, such as PromptV2.0.

The computing system generates the unique agent identifier for each AI agent based on one or more of these metadata elements (e.g., an application name and version, a model name and version of the AI agent, parameters used to execute the AI agent, a knowledge-base version used by the AI agent, and/or a prompt version) and/or other metadata elements. To generate the unique agent identifier, the computing system combines one or more of the above metadata elements as well as any additional metadata elements not discussed here. Using the metadata examples above (App Tag, Model Tag, Parameters Tag, Knowledge Base Tag, and Prompt Version Tag), the computing system can generate a unique agent identifier for a given AI agent, such as: InvoiceGen_1.2.0_GPT4_2023.09_ T0.7_MT1000_ CustomerSupportKB_3.1_Public_ PromptV2.0.

The computing system generates the unique agent identifier for each AI agent upon detecting a release of each AI agent in the given networked system. For example, the computing system determines that a new AI agent has been added or implemented in the given networked system and generates a unique agent identifier for the new AI agent, as explained above. The computing system stores each unique agent identifier for each AI agent that is utilized in the networked system. For example, the unique agent identifiers can be stored in a centralized traceability metadata repository, such as in one or more databases 126. This repository can capture metadata, configuration, context and execution trails for auditing and lookup purposes.

In some examples, during every invocation, the computing system logs the unique agent identifier, the relevant application environmental variables/context, and the timestamp in an immutable Agent Activity Ledger to establish a time-series record of agent usage by business application, across the networked system.

In operation 204, the computing system detects execution of an AI agent in the networked system. For example, the computing system can detect each execution of a plurality of executions for each of a plurality of AI agents utilized in the networked system. For each detected execution, the computing system can perform, in real time or near real time, operations comprising generating a data unique tag and assigning the data unique tag to AI-generated data generated from the execution of the AI agent, as shown in operation 206.

In some examples, the computing system generates the data unique tag based on the unique agent identifier associated with an AI agent that was executed, a time stamp associated with execution, and contextual metadata. In this way, AI-generated data is inherently tied to its originating agent, ensuring a clear attribution feature. The computing system assigns each piece of AI-generated data with metadata that can include a unique agent identifier, a timestamp and context metadata.

The unique agent identifier links the data to the associated AI agent. The timestamp records the time of data generation of the AI-generated data, ensuring chronological traceability. For example, the timestamp can be an ISO-8601 formatted timestamp, such as 2004-12-22T15:45:30Z. The contextual metadata optionally includes additional content, such as the wider business application version and/or the environment variables of the business application version.

The data unique tag can further comprise a sequence number. The sequence number can be used to ensure uniqueness across multiple data outputs (AI-generated data) within a single execution. An example sequence number can be Seq001.

To generate the data unique tag, the computing system can combine one or more of the above elements as well as any additional elements not discussed here.

Accordingly, and example data unique tag can include one or more of [UniqueIdentifierAIagent]_[Timestamp]_[SequenceNo]. For instance, using the examples from above an example data unique tag can be: InvoiceGen_1.2.0_GPT4_2023.09_ T0.7_MT1000_CustomerSupportKB_3.1_Public_PromptV2.0_2004-12-22T15:45:30Z_Seq 001.

In some examples, the computing system stores each data unique tag in an AI Data Registry, such as in one or more databases 126. The AI Data Registry associates generated content with its metadata through the data unique tag.

In one example, the computing system generates a cryptographic hash of the AI-generated data generated from the execution of the AI agent and stores the cryptographic hash (e.g., SHA-256) with the data unique tag associated with the AI-generated data generated from the execution of the AI agent. Using a cryptographic hash can ensure integrity and enable detection of tampering.

In operation 208, the computing system detects that data generated from execution of one or more AI agents of the plurality of AI agents has been accessed by a downstream application. This data is referred to herein as “accessed data.” For example, the computing system detects that the downstream application links to or imports data generated from execution of one or more AI agent of the plurality of AI agents.

Based on detection of the accessed data, the computing system generates a watermark, also referred to herein as a “lineage tag,” for new data created by the downstream application. The watermark is based on each data unique tag associated with the accessed data, as shown in operation 210. The new data is considered AI-influenced data because it refers to data that has been shaped, modified, or augmented by AI-generated content. To maintain traceability, the computing system embeds system-wide watermarks and relational mappings that capture an attribution to AI-generated data, an attribution to an AI agent, and a cumulative influence record.

For the attribution to AI-generated data, the computing system applies watermarks, or unique identifiers, to AI-influenced data, allowing the computing system to identify which specific AI-generated content contributed to its creation, access, modification or deletion. Each watermark also traces back to the unique agent identifier or the originating AI agent. As for the cumulative influence record, for data influenced by multiple AI-generated data or AI agents, the computing system creates a composite influence record that documents the chain of influence, including all the above for each contributing instance.

This level of traceability ensures that any AI-influenced data can be reverse-engineered to its original AI-generated inputs and associated agents. Such capabilities enable auditing and compliance, detection of potential biases, and verification of model outputs across dynamic system landscapes. By implementing this three-level traceability mechanism, the AI traceability system 124 establishes a robust framework for monitoring and documenting the lifecycle of GenAI-influenced business applications, fostering enterprise-readiness, accountability, transparency, resilience, governance, risk management and compliance adherence.

For example, the new data (e.g., AI-influence data) is tagged with a lineage tag that captures its relationships with both AI-generated data and the originating AI agent. This lineage schema includes the data unique tag (DUT) for the AI-generated data, transformation details, and a timestamp.

A list of all data unique tags for influencing AI-generated data is included. An example format for a single-source influence can be Parent: [DUT_ID] and for multi-source influence, an example format can be: Parent: [DUT_ID1, DUT_ID2, . . . ].

The transformation details indicate how the accessed data was used, such as by describing modification or augmentation process, such as in the format:

Transformation: [Summarization]. In some examples, the transformation details include one or more of summarization, text-to-text transformation, augmentation, data generation, data blending, or modifications made to the accessed data (e.g., AI-generated data).

The timestamp is the time when the influence was applied, such as 2024-12-22T16:10:45Z.

To generate the watermark for the new data, the computing system combines one or more of the above elements as well as any additional elements not discussed here. For instance, using the examples from above, an example watermark can be: Parent:[DUT_ID 1, DUT_ID2, . . .]_ Transformation:[Summarization]_ 2024-12-22T16:10:45Z.

The computing system stores the watermark with the new data to enable tracing of AI influence across the given networked system. In some examples, the computing system stores the watermark with the new data by embedding the watermark directly in the new data or applying a cryptographic watermark to the new data. For instance, for structured formats, such as JSON or XML, the watermark can be embedded directly in the data file for the new data. For unstructured formats, such as text or images, a cryptographic watermark is applied, encoding the lineage tag preserving any other feature from the original file.

In some examples, the computing system stores the watermarks in a data lineage registry, such as in one or more databases 126, that enables backtracking from influenced data to its originating sources. The registry also supports queries to identify all downstream influences of specific AI-generated content.

In some examples, the AI traceability system 124 comprises a traceability orchestrator. The traceability orchestrator is a central service configured to coordinate the generation, management, and validation of unique agent identifiers, data unique tags, and lineage tags. It interacts with the Traceability Metadata Repository, AI Data registry, and Data Lineage Registry to maintain comprehensive traceability.

The AI traceability system 124 can further provide APIs (e.g., via API server 120) for seamless integration with business applications, allowing them to tag and trace AI-influenced processes programmatically. By implementing the tagging and centralized registry system, the AI traceability system 124 achieves robust, end-to-end traceability, addressing critical needs for accountability, compliance, and transparency in AI-powered business ecosystems.

The AI traceability system 124 can further provide interfaces to enable display and reporting of information about which AI agents and AI-generated data were used in given AI-influenced data. In this way, the computing system can cause display, on a display of a computing device (e.g., client device 110), of the lineage of the given AI-influenced data, based on the watermark or lineage tag for the given AI-influenced data. The computing system can further generate one or more reports indicating the lineage of various AI-influenced data and cause the generated one or more report to be displayed on a display of a computing device. For example, a user can request a report for data generated by AI or influenced by data generated by AI and the computing system accesses the data lineage registry to generate the report based on the composite influence record that documents the chain of influence, as described above. Accordingly, reporting can further be provided against controls derived from the following AI-focused standards, norms or regulations, e.g., ISO/IEC 42001:2023 (AI Management System Standard), ISO/IEC 23894:2023 (AI Risk Management), ISO/IEC TR 24027:2021 (Bias in AI systems and AI-aided decision making), ISO/IEC 24028:2022 (AI Trustworthiness), ISO/IEC 38507:2022 (Governance implication of AI), IEEE 7000 Series (AI Ethics and Societal Impacts Standards), EU AI Act, EU Ethics Guidelines for Trustworthy AI, NIST AI, Executive Order on Safe, Secure and Trustworthy AI, OECD AI Principles.

The AI traceability system 124 comprises a framework that enables seamless tracking of the data provenance, agent behavior, and process outcomes. This AI traceability system 124 not only enhances operational transparency but also facilitates proactive risk management, bias mitigation, and model improvement through actionable insights delivered from the traceability data and the controls applied to it.

The AI traceability system 124 addresses key technical challenges such as scalability, interoperability with existing business systems, and real-time traceability in dynamic AI-driven environments. By embedding traceability as a core component of AI applications (e.g., GenAI applications), with the AI traceability system 124 organizations gain the control and assurance needed to achieve compliant AI deployments, build robust stakeholder trust, and maximize AI's innovative capabilities, while ensuring alignment with all non-functional requirements.

The AI traceability system 124 further enables fine-grained attribution with the ability to tag and identify version, configuration, and context of AI-powered agents used to generate data. The AI traceability system 124 also enables systematic linking of outputs to inputs by enabling mechanisms to establish clear relationships between generated data and the original agent through robust metadata tagging and timestamping. Further, the AI traceability system 124 provides comprehensive influence mapping using techniques such as watermarking or relational mapping to track the cascading effects of AI-generated data on subsequent processes and outputs.

The AI traceability system 124 further provides for data protection and data privacy, such as anonymized data for privacy, compliance, and legal purposes; protected data using encryption or other method; or ensuring data is not disclosed, such as training data for third-party models. The provided data protection and data privacy can address a given system's requirements for data protection and privacy. As one example, the AI traceability system may not assign prompts to named users. As another example, the AI traceability system 124 may not log responses or database result sets, but instead only log metadata or a query string. Also, certain data may not be disclosed by vendors, including training data sets. Accordingly, the schema has flexibility to accommodate for anonymized, protected or even missing data elements.

The AI traceability system 124 can further protect against user behavior tracking or other system misuse. Each data element, as well as the record as a whole, can be individually protected, access-controlled and monitored. In this way, users or administrators of the AI traceability system 124 can initiate a trace, parcel out different components to different stakeholders, and only allow a given stakeholder access to what the given stakeholder needs to provide the administrator with the information they need for an entire trace. In some examples, access can be restricted, such as by encrypting each data element with its own (symmetric) encryption key. Then access keys will be provisioned to appropriate stakeholders controlling access to the data appropriate only to the respective stakeholder's scope. Finally, a message key can encrypt an entire message, with a message access key provisioned to those who can orchestrate a trace.

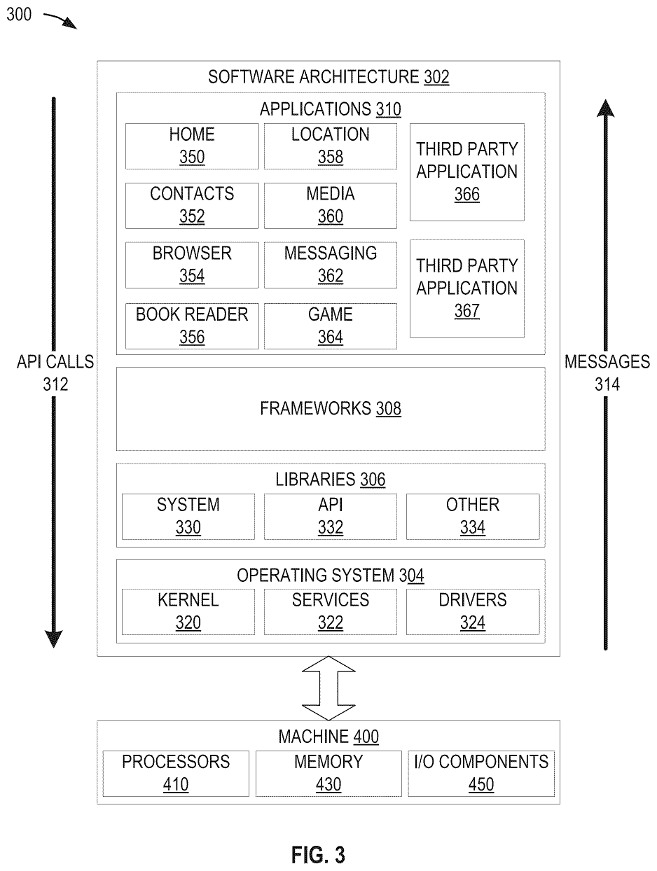

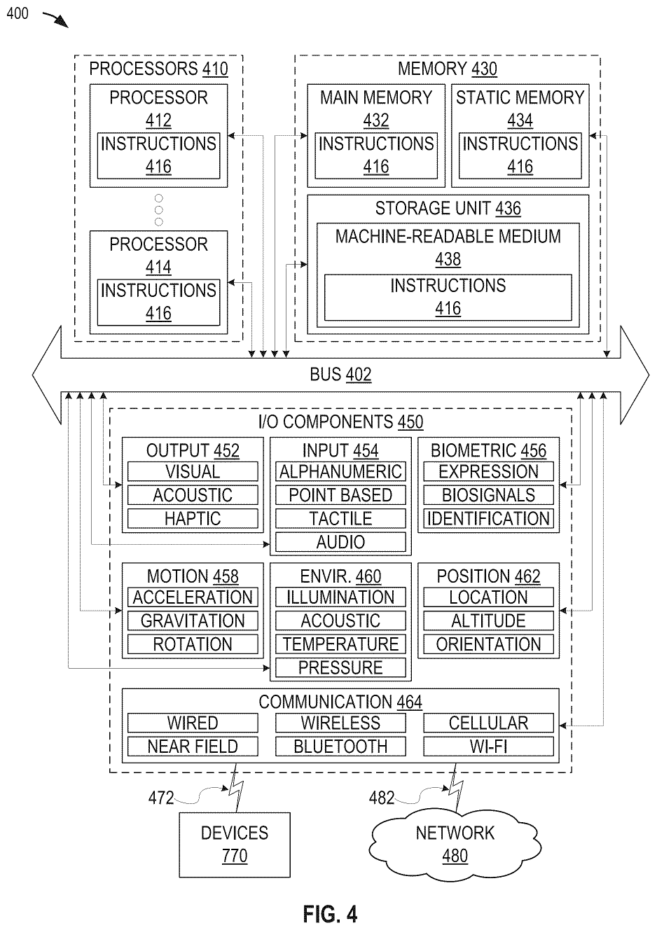

FIG. 3 is a block diagram 300 illustrating software architecture 302, which can be installed on any one or more of the devices described above. For example, in various embodiments, client devices 110 and servers and systems 130, 120, 122, and 124 may be implemented using some or all of the elements of software architecture 302. FIG. 3 is merely a non-limiting example of a software architecture, and it will be appreciated that many other architectures can be implemented to facilitate the functionality described herein. In various embodiments, the software architecture 302 is implemented by hardware such as machine 400 of FIG. 4 that includes processors 410, memory 430, and input/output (I/O) components 450. In this example, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke application programming interface (API) calls 312 through the software stack and receive messages 314 in response to the API calls 312, consistent with some embodiments.

In various embodiments, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various graphical user interface (GUI) functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications such as third-party applications 366 and 367. According to some embodiments, the applications 310 are programs that execute defined functions. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the developer of any particular platform) may be mobile software running on a mobile operating system such as IOST, ANDROID™, WINDOWS® Phone, or another mobile operating system. In this example, the third-party application 366 can invoke the API calls 312 provided by the operating system 304 to invoke or leverage the functionality described herein.

FIG. 4 is a block diagram illustrating components of a machine 400, according to some embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application 310, an applet, an app, or other executable code) for causing the machine 400 to perform any one or more of the methodologies discussed herein can be executed. In alternative embodiments, the machine 400 operates as a standalone device or can be coupled (e.g., networked) to other machines. In a networked deployment, the machine 400 may operate in the capacity of a server machine or system 130, 102, 120, 122, 124, etc., or a client device 110 in a server-client network environment, or as a peer machine in a peer-to-peer (or distributed) network environment. The machine 400 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

In various embodiments, the machine 400 comprises processors 410, memory 430, and I/O components 450, which can be configured to communicate with each other via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 412 and a processor 414 that may execute the instructions 416. The term “processor” is intended to include multi-core processors 410 that may comprise two or more independent processors 412, 414 (also referred to as “cores”) that can execute instructions 416 contemporaneously. Although FIG. 4 shows multiple processors 410, the machine 400 may include a single processor 410 with a single core, a single processor 410 with multiple cores (e.g., a multi-core processor 410), multiple processors 412, 414 with a single core, multiple processors 412, 414 with multiples cores, or any combination thereof.

The memory 430 comprises a main memory 432, a static memory 434, and a storage unit 436 accessible to the processors 410 via the bus 402, according to some embodiments. The storage unit 436 can include a machine-readable medium 438 on which are stored the instructions 416 embodying any one or more of the methodologies or functions described herein. The instructions 416 can also reside, completely or at least partially, within the main memory 432, within the static memory 434, within at least one of the processors 410 (e.g., within the processor's cache memory), or any suitable combination thereof, during execution thereof by the machine 400. Accordingly, in various embodiments, the main memory 432, the static memory 434, and the processors 410 are considered machine-readable media 438.

As used herein, the term “memory” refers to a machine-readable medium 438 able to store data temporarily or permanently and may be taken to include, but not be limited to, random-access memory (RAM), read-only memory (ROM), buffer memory, flash memory, and cache memory. While the machine-readable medium 438 is shown, in an example embodiment, to be a single medium, the term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions 416, when executed by one or more processors of the machine 400 (e.g., processors 410), cause the machine 400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 450 include a wide variety of components to receive input, provide output, produce output, transmit information, exchange information, capture measurements, and so on. In general, it will be appreciated that the I/O components 450 can include many other components that are not shown in FIG. 4. The I/O components 450 are grouped according to functionality merely for simplifying the following discussion, and the grouping is in no way limiting. In various example embodiments, the I/O components 450 include output components 452 and input components 454. The output components 452 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 454 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 450 include biometric components 456, motion components 458, environmental components 460, or position components 462, among a wide array of other components. For example, the biometric components 456 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 include acceleration sensor components (e.g., accelerometer), gravitation sensor components, rotation sensor components (e.g., gyroscope), and so forth. The environmental components 460 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 462 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 450 may include communication components 464 operable to couple the machine 400 to a network 480 or devices 470 via a coupling 482 and a coupling 472, respectively. For example, the communication components 464 include a network interface component or another suitable device to interface with the network 480. In further examples, communication components 464 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 470 may be another machine 400 or any of a wide variety of peripheral devices (e.g., a peripheral device coupled via a Universal Serial Bus (USB)).

Moreover, in some embodiments, the communication components 464 detect identifiers or include components operable to detect identifiers. For example, the communication components 464 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 464, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 480 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 416 are transmitted or received over the network 480 using a transmission medium via a network interface device (e.g., a network interface component included in the communication components 464) and utilizing any one of several well-known transfer protocols (e.g., Hypertext Transfer Protocol (HTTP)). Similarly, in other example embodiments, the instructions 416 are transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

Furthermore, the machine-readable medium 438 is non-transitory (in other words, not having any transitory signals) in that it does not embody a propagating signal. However, labeling the machine-readable medium 438 “non-transitory” should not be construed to mean that the medium is incapable of movement; the machine-readable medium 438 should be considered as being transportable from one physical location to another. Additionally, since the machine-readable medium 438 is tangible, the machine-readable medium 438 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A computer-implemented method comprising:
generating a unique agent identifier for each artificial intelligent (AI) agent of a plurality of AI agents utilized in a given networked system;
detecting each execution of a plurality of executions of each of the plurality of AI agents utilized in the given networked system;
for each detected execution, performing, in real time or near real time, operations comprising:
generating a data unique tag comprising the unique agent identifier associated with an AI agent that was executed, a time stamp associated with execution, and contextual metadata; and
assigning the data unique tag to AI-generated data generated from the execution of the AI agent;
detecting AI-generated accessed by a downstream application, the AI-generated data generated from execution of a subset of the plurality of AI agents;
generating a lineage tag for new data created that is created by the downstream application using the AI-generated data, the lineage tag comprising each data unique tag associated with each of the AI-generated data used to generate the new data; and
storing the lineage tag with the new data to enable tracing of AI influence across the given networked system.

2. The computer-implemented method of claim 1, wherein the unique agent identifier for each AI agent is based on an application name and version, a model name and version of the AI agent, parameters used to execute the AI agent, a knowledge-base version used by the AI agent, and a prompt version.

3. The computer-implemented method of claim 1, further comprising:
detecting a release of a new AI agent in the given networked system; and
generating a unique agent identifier for the new AI agent based on an application name and version, a model name and version of the new AI agent, parameters used to execute the new AI agent, a knowledge-base version used by the new AI agent, and a prompt version.

4. The computer-implemented method of claim 3, wherein the parameters include a temperature setting and a maximum token setting.

5. The computer-implemented method of claim 1, wherein the unique agent identifier for each AI agent is generated upon detecting release of each AI agent in the given networked system.

6. The computer-implemented method of claim 1, further comprising:
storing, in a datastore, each unique agent identifier for each AI agent of the plurality of AI agents utilized in the given networked system.

7. The computer-implemented method of claim 1, wherein the data unique tag further comprises a sequence number.

8. The computer-implemented method of claim 1, further comprising:
generating a cryptographic hash of the AI-generated data generated from the execution of the AI agent; and
storing the cryptographic hash with the data unique tag associated with the AI-generated data generated from the execution of the AI agent.

9. The computer-implemented method of claim 1, wherein the lineage tag is further based on transformation details indicating how the AI-generated data was used.

10. The computer-implemented method of claim 9, wherein the transformation details include one or more of summarization, text-to-text transformation, augmentation, data generation, or data blending.

11. The computer-implemented method of claim 1, wherein the lineage tag is further based on metadata describing modifications made to the AI-generated data.

12. The computer-implemented method of claim 1, wherein storing the lineage tag with the new data comprises embedding the lineage tag directly in the new data or applying a cryptographic lineage tag to the new data.

13. The computer-implemented method of claim 1, wherein detecting access by a downstream application of data generated from execution of one or more AI agent of the plurality of AI agents comprises:
detecting that the downstream application links to or imports data generated from execution of one or more AI agent of the plurality of AI agents.

14. A system comprising:
a memory that stores instructions; and
one or more processors configured by the instructions to perform operations comprising:
generating a unique agent identifier for each artificial intelligent (AI) agent of a plurality of AI agents utilized in a given networked system;
detecting each execution of a plurality of executions of each of the plurality of AI agents utilized in the given networked system;
for each detected execution, performing, in real time or near real time, operations comprising:
generating a data unique tag comprising the unique agent identifier associated with an AI agent that was executed, a time stamp associated with execution, and contextual metadata; and
assigning the data unique tag to AI-generated data generated from the execution of the AI agent;
detecting AI-generated accessed by a downstream application, the AI-generated data generated from execution of a subset of the plurality of AI agents;
generating a lineage tag for new data created that is created by the downstream application using the AI-generated data, the lineage tag comprising each data unique tag associated with each of the AI-generated data used to generate the new data; and
storing the lineage tag with the new data to enable tracing of AI influence across the given networked system.

15. The system of claim 14, wherein the unique agent identifier for each AI agent is based on an application name and version, a model name and version of the AI agent, parameters used to execute the AI agent, a knowledge-base version used by the AI agent, and a prompt version.

16. The system of claim 14, the operations further comprising:
detecting a release of a new AI agent in the given networked system; and
generating a unique agent identifier for the new AI agent based on an application name and version, a model name and version of the new AI agent, parameters used to execute the new AI agent, a knowledge-base version used by the new AI agent, and a prompt version.

17. The system of claim 16, wherein the parameters include a temperature setting and a maximum token setting.

18. (canceled)

19. (canceled)

20. A non-transitory computer-readable medium comprising instructions stored thereon that are executable by at least one processor to cause a computing device to perform operations comprising:
generating a unique agent identifier for each artificial intelligent (AI) agent of a plurality of AI agents utilized in a given networked system;
detecting each execution of a plurality of executions of each of the plurality of AI agents utilized in the given networked system;
for each detected execution, performing, in real time or near real time, operations comprising:
generating a data unique tag comprising the unique agent identifier associated with an AI agent that was executed, a time stamp associated with execution, and contextual metadata; and
assigning the data unique tag to AI-generated data generated from the execution of the AI agent;
detecting AI-generated accessed by a downstream application, the AI-generated data generated from execution of a subset of the plurality of AI agents;
generating a lineage tag for new data created that is created by the downstream application using the AI-generated data, the lineage tag comprising each data unique tag associated with each of the AI-generated data used to generate the new data; and
storing the lineage tag with the new data to enable tracing of AI influence across the given networked system.

21. The computer-implemented method of claim 1, further comprising:
causing display on a computing device of a lineage for the new data, the lineage based on each lineage tag associated with each of the AI-generated data used to generate the new data.

22. The computer-implemented method of claim 1, wherein the contextual metadata comprises a business application version or environmental variables of a business application version.
